(19) United States
(12) Patent Application Publication
(10) Pub. No.: US 2015/0239212 A1
(43) Pub. Date: Aug. 27, 2015

(54) LAYERED COMPOSITE MATERIAL

(71) Applicant: SGL CARBON SE, WIESBADEN (DE)

(72) Inventors: SEBASTIAN FROMMELT, WESTENDORF (DE); KARL HINGST, AUGSBURG (DE); MARKUS SCHROEDER, DINKELSCHERBEN (DE); RICHARD MAYR, THIERHAUPTEN (DE); ROLAND STETTBERGER, NORDENDORF (DE)

(21) Appl. No.: 14/707,225

(22) Filed: May 8, 2015

Related U.S. Application Data
(63) Continuation of application No. PCT/EP2013/073232, filed on Nov. 7, 2013.

(30) Foreign Application Priority Data
Nov. 8, 2012 (DE) 10 2012 220 310.9

(51) Int. Cl. B32B 9/00

(52) U.S. Cl. CPC B32B 9/007; B32B 2581/00

(57) ABSTRACT

A layered composite material component has two or more layers of graphite foil. The layers of graphite foil are connected together by way of at least one connecting pin that engages in both layers in a form-fitting manner.

### CROSS-REFERENCE TO RELATED APPLICATION

This application is a continuation, under 35 U.S.C. §120, of copending international application No. PCT/EP2013/073232, filed Nov. 7, 2013, which designated the United States; this application also claims the priority, under 35 U.S.C. §119, of German patent application No. DE 10 2012 220 310.9, filed Nov. 8, 2012; the prior applications are herewith incorporated by reference in their entirety.

### BACKGROUND OF THE INVENTION

### Field of the Invention

The present invention relates to a layered composite material which comprises at least two layers of graphite foil.

Layered composite materials of this type are used for example for producing seals for high-temperature furnaces, during the operation of which the seals are subjected to temperatures for example of greater than 600° C. or even of greater than 1800° C., or for producing seals for plants in the chemical industry, during the operation of which the seals are frequently exposed to a highly corrosive environment. The graphite foils used therein are conventionally produced by expanding graphite, in particular natural graphite, and subsequently compressing the expanded particles. By means of the compression process, the individual graphite particles are interlocked so that planar graphite bodies in the form of foils or plates can be produced without adding binders. Graphite bodies of this type are distinguished in particular by a high temperature resistance and corrosion resistance and by a low permeability to liquids and gases.

However, on account of the method, graphite foils of this type cannot be produced having unlimited thicknesses. Therefore, only a multi-layer construction can be considered for applications for which a corresponding thickness is required, such as the use as a seal in a high-temperature furnace.

In order to ensure a stable composite in multi-layer constructions of this type, which is necessary for example in order to be able to handle the composite from the time of the production thereof until the installation thereof at the destination, the individual foil layers are conventionally glued together. However, the gluing is associated with relatively complex operation steps. In addition, the problem arises in this case that, when an adhesive is used, carbonisation and graphitisation of the component in question is necessary after the gluing in order to achieve the purity level required for conventional applications, which is, however, associated with significant additional outlay. Furthermore, during the heat treatment of the foil stack in an appropriate furnace, which heat treatment is required for the carbonisation and graphitisation, blistering may occur in the material, which is unacceptable in numerous applications.

### SUMMARY OF THE INVENTION

It is accordingly an object of the invention to provide a layered composite which overcomes the above-mentioned and other disadvantages of the heretofore-known devices and methods of this general type and provides for a layered composite material, formed of at least two graphite foil layers, which is stable and fluid-tight and yet simple to produce.

With the foregoing and other objects in view there is provided, in accordance with the invention, a layered composite material, comprising:

at least two layers of graphite foil;

at least one connecting pin connecting the at least two layers of graphite foil to one another. The at least one connecting pin engages in each of the at least two layers with a form-fit.

In other words, the objects of the invention are achieved by a layered composite material with at least two graphite foil layers of the layered composite material interconnected by means of at least one connecting pin which engages at least with a form-fit in the two layers. The term form fit or form fitting connection is equivalent to the term positive fit or positive connection, namely, a connection between two parts in which the parts themselves provide for a shape that opposes their separation.

The individual foil layers are therefore not glued, as is conventional in the prior art, but rather pinned. As a result, not only the complex application of the adhesive layer(s), but also the carbonisation and graphitisation, are dispensed with, so that the layered composite material does not need to be subjected to any additional heat treatment during manufacture and consequently there is no longer the risk of blistering. In the context of the present invention, a pin means an elongate element, such as in particular a bolt, peg, key, cone or the like, the remainder of the geometry and in particular the cross-sectional shape being in principle arbitrary. Depending on the shape, the size and the raw material, the connecting pin can be produced by means of turning, grinding, punching, cutting, stamping or similar methods.

A particular advantage of the present invention is that a connecting pin is simple and cost-effective to produce. However, due to the form-fit engagement, a high degree of connection stability is nonetheless ensured. The present invention relates inter alia to the finding that pinning with a form-fit is sufficient for safely handling the stack of flexible and relatively thin graphite foil layers until assembly; there is therefore no need whatsoever to glue the layers together over the entire surface areas thereof. As soon as the sealing component formed by the foil stack has been installed at the destination, the clamping forces acting perpendicularly to the stack surface mean that there is in any case no longer any danger of the stack falling apart. On account of its elongate design, the connecting pin, which then in principle has no function, then impairs the permeability and the heat-conducting behaviour of the seal to only a very limited extent, if at all.

It is important in this case for at least two layers to be interconnected by a connecting pin if more than two layers of graphite foil are present in a layered composite material. Therefore, if the layered composite material comprises for example four layers of graphite foil, it is sufficient in principle for merely two layers to be interconnected by a connecting pin. However, in order to achieve a high overall stability of the layered composite material it is preferred for all the layers of graphite foil present to be interconnected using at least one connection pin.

A preferred embodiment of the present invention provides for the at least two layers of graphite foil to be interconnected by means of at least one connecting pin engaging with a form-fit and force-fit in the two layers. The stability of the composite can be further increased by the combination of a form-fit and force-fit connection. The term force fit or force fitting connection is equivalent to the term friction fit or frictional force connection.

The longitudinal axis of the at least one connecting pin preferably extends at right angles or obliquely to the planar extension of the layered composite material. In other words, the connecting pin preferably does not extend in parallel with the surface of the foil stack, but rather transversely thereto. For example, the longitudinal axis can be inclined by approximately 10° to the surface normal. Then, no engagement elements protruding from the connecting pin are necessary, since the form-fit connection between the at least two layers is achieved by the pin body itself. Additional engagement elements can nonetheless be provided on the connecting pin should the application require.

According to a further preferred embodiment of the present invention, the at least two layers of graphite foil are interconnected by means of at least two connecting pins, the longitudinal axes of which are differently inclined with regard to the planar extension of the layered composite material. In this case, the longitudinal axes may differ from one another in the inclination angle and/or the inclination direction thereof. The cohesion of the layered composite material can be achieved to a particularly high degree by means of differently inclined connecting pins of this type.

Furthermore, it is preferred that at least one end of the at least one connecting pin be offset backwards by a buffer distance relative to the closest outer surface of the layered composite material. That is to say that the connecting pin preferably does not penetrate the surfaces of the outermost layer, but rather extends merely in part through the layered composite material. Preferably, the connecting pin is entirely embedded in the composite material. In this case, and according to a particularly preferred embodiment of the present invention, the buffer distance between the end of the pin and the outer surface of the layered composite material is at least 1 mm. This takes account of the fact that the material can be compressed when using the layered composite material as a seal, in which case the buffer distance prevents force from being directly applied to the connecting pin in an undesirable manner. In addition, thermal bridges can be minimised or even entirely prevented thereby in a particularly advantageous manner.

In principle, the connecting pin can also extend through the entire layered composite material, it being preferred in this case for the connecting pin to lock at least flush with the outer surfaces of the layered composite material in order to ensure sufficient stability and in order not to impair the compressibility of the overall construction. Since the cross-sectional area of the connecting pin is conventionally considerably smaller than the overall surface of the foil stack, in this case too, the formation of thermal bridges on account of the pin is only relatively low.

In a development of the present invention, it is further proposed that, in each case, two of the at least two layers of graphite foil connected by at least one connecting pin be directly adjacent to each other. It is therefore preferred for no intermediate layer or separating layer to be arranged between adjacent layers, since this allows a particularly simple construction. However, this is not essential, i.e. depending on the application, the layered composite material can also comprise additional layers made from other materials, such as reinforcing layers made from sheet metal, which are inserted between two layers of graphite foil in each case.

According to a further preferred embodiment of the present invention, the at least two layers of graphite foil are interconnected exclusively by means of the at least one connecting pin, and in particular in an adhesive-free manner. This allows particularly simple and cost-effective production.

In addition, it is preferred for the at least two layers of graphite foil to consist entirely of compressed expanded, in particular binder-free, graphite.

In accordance with an added feature of the invention, the at least two layers of graphite foil, and preferably each of the at least two layers of graphite foil, have a thickness of between 0.2 mm and 10 mm and preferably of between 1 mm and 3 mm. Graphite foils of this foil thickness are simple to produce by way of conventional methods.

In accordance with an additional feature of the invention, the at least two layers of graphite foil, and preferably each of the at least two layers of graphite foil, have a bulk density of between 0.5 g/cm³ and 2 g/cm³, and particularly preferably between 0.7 g/cm³ and 1.3 g/cm³. Graphite foils of this type are particularly suitable for high-temperature resistant and corrosion resistant seals.

According to a further preferred embodiment of the present invention, it is provided that the layered composite material has a total thickness of between 2 mm and 50 mm, preferably of between 4 mm and 40 mm, and more preferably of between 5 mm and 30 mm. Layered composite materials of this thickness have proven particularly beneficial for applications of the type mentioned at the outset.

In a development of the inventive concept, it is proposed in addition that the layered composite material comprises at least 3, preferably between 3 and 50, more preferably from 3 to 5, and most preferably 4 or 5 layers of graphite foil.

In this case, the at least three layers of graphite foil can also be interconnected by means of at least two connecting pins, each of the at least two connecting pins engaging merely in two adjacent layers of the at least three layers of graphite foil. By means of this measure, in particular undesired thermal bridges can be reduced to a minimum or even entirely avoided.

In order to reinforce this effect even more, the positions of the at least two connecting pins can in addition be offset from one another with respect to the planar extension of the layered composite material.

Good results are achieved in particular if the at least one connecting pin is produced from a material selected from the group consisting of carbon, graphite, composite materials containing carbon fibres, felt, silicon carbide, metals, ceramic materials and any combination of two or more of the aforementioned materials. It is preferred, in this case, for the connecting pin to consist entirely of a composite material containing carbon fibres, of graphite, or of steel.

According to a specific embodiment of the invention, the at least one connecting pin is produced from graphite foil. A high level of homogeneity of the layered composite material is thereby achieved.

In accordance with a further feature of the invention, the at least one connecting pin is cylindrical in shape, i.e. the cross section of the connecting pin is preferably circular. Connecting pins of this type are particularly simple and cost-effective to produce. In principle, however, the connecting pin may also be of another shape, for example an elliptical, square or hexagonal cross section.

Furthermore, the at least one connecting pin may be tapered at least in portions with regard to the longitudinal axis thereof and may be for example conical in shape. A tapered design of this type can facilitate driving the pin into the foil stack and assist in the production of a force-fit connection.

In addition, the at least one connecting pin may also have a textured surface. For example, the surface of the connecting pin could be corrugated or serrated at least in regions. However, texturing can only consist in a comparatively high degree of roughness of the pin surface. In contrast with a smooth pin surface, a design of the connecting pin having a textured surface allows increased frictional resistance and thus improved cohesion of the layers.

If a particularly high connection strength is desired, the at least one connecting pin can advantageously further comprise a thread and/or a winding hook.

According to a further embodiment of the present invention, the at least one connecting pin has an outer diameter of between 1 mm and 5 mm, preferably of between 1.5 mm and 4 mm and more preferably of between 2 mm and 3 mm. Furthermore, the at least one connecting pin can have a length of between 1 mm and 20 mm, and preferably of between 2 mm and 5 mm. The dimensions of the connecting pin depend specifically on the measurements of the overall construction and the required connection strength.

In principle, however, it is preferred for the at least one connecting pin to have a length which is smaller than the sum of the thicknesses of the layers of graphite foil interconnected by the connecting pin. Undesired heat-conduction losses are thereby minimised and a direct application of pressure on the connecting pin in the event of compression of the layered composite material is thereby prevented.

In order to allow a reliable form-fit, a recess for receiving the at least one connecting pin can in addition be provided in each of the at least two layers of graphite foil. The recess can be produced prior to connecting the layers, by means of drilling or milling. Alternatively, dispensing with all kinds of recesses can also be considered, in order to save the associated operation steps, such as predrilling. The connecting pin can then be shot into the foil stack, for example by means of a shooting device.

In order to further increase the stability, the at least one connecting pin can be received in the recesses, forming an interference fit. A connecting pin in an interference fit allows for a combination of a form-fit and force-fit connection.

According to a further preferred embodiment of the present invention, it is provided for at least one of the recesses to be formed as a blind hole. This has the effect that the formation of thermal bridges is minimized.

The present invention further relates to a component, in particular a seal, which comprises at least one layered composite material configured in the manner described above.

In addition, the present invention relates to the use of a layered composite material or component configured in the manner described above as a seal, in particular at a temperature of at least 600° C., preferably of at least 800° C., more preferably of at least 1000° C., and most preferably of at least 1800° C.

Other features which are considered as characteristic for the invention are set forth in the appended claims.

Although the invention is illustrated and described herein as embodied in a layered composite material, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a lateral sectional view of a layered composite material according to the invention, formed with five layers of graphite foil.

FIGS. 2a-2e are respective plan views of the layered composite material according to FIG. 1, illustrating the positioning of the connecting pins connecting the individual layers of graphite foil.

### DETAILED DESCRIPTION OF THE INVENTION

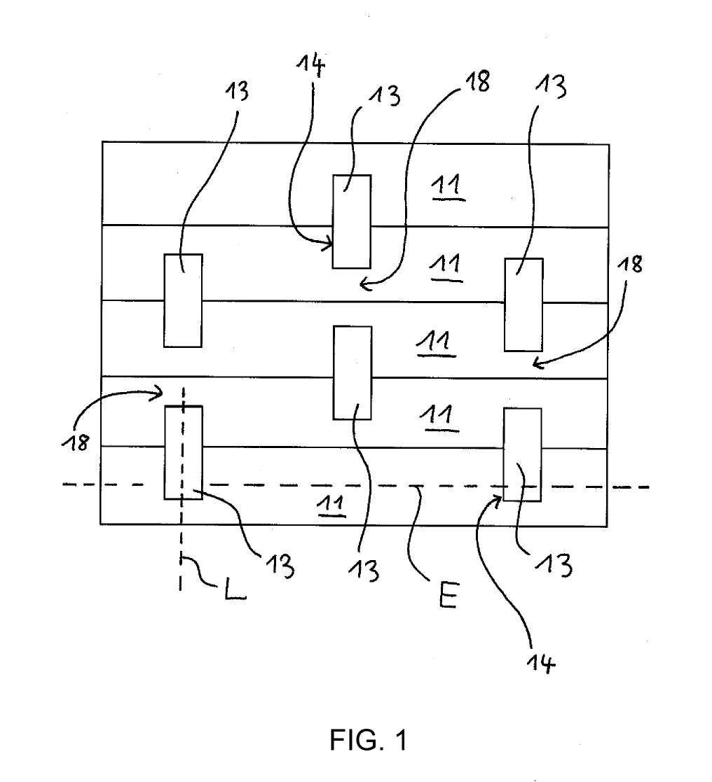

Referring now to the figures of the drawing in detail and first, particularly, to FIG. 1 thereof, there is shown a high-temperature seal according to the invention. The assembly is formed as a layered composite and comprises five layers 11, in the form of graphite foil plates, stacked on top of one another. The individual layers 11 are each 3 mm thick and consist entirely of compressed expanded natural graphite. For example, a graphite foil of the trade mark Sigraflex®, material type L30010C can be used. The five layers 11 are pinned together using a plurality of cylindrical connecting pins 13 to form an overall plate forming the high-temperature seal. In this case, the connecting pins 13 are produced from a composite material containing carbon fibres or from graphite, and are worked to a length of 5 mm. In the present embodiment, the outer diameter of the connecting pins 13 is 3 mm. In this case, the longitudinal axis L of the connecting pins 13 extends, in the embodiment shown, at right angles to the plane E of the layers, i.e. to the planar extension of the layers 11.

In order to produce the layered composite material, blind holes 14 for receiving the connecting pins 13 are bored into the layers 11 by means of a 3 mm steel drill. The layers 11 are subsequently pinned together, in each case a set of four connecting pins 13 being inserted into the associated blind hole 14 of a layer 11 and a following layer 11 being laid on the lower layer 11 in a manner having correspondingly positioned blind holes 14.

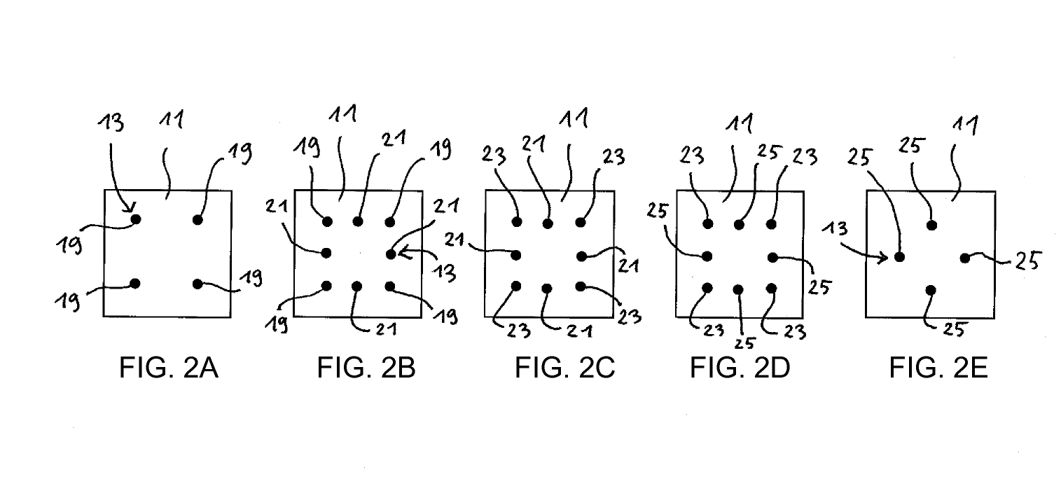

Since the thickness of two layers 11 stacked on top of each other is 6 mm, but the connecting pins 13 are only 5 mm long, buffer zones 18 result, which prevent a direct application of pressure on the connecting pins 13. In addition, the positions of the connecting pins 13 change from layer to layer, as will be described in more detail below with reference to FIG. 2a-2e.

According to FIG. 2a, the first, i.e. the bottom, layer 11, contains four connecting pins 13 in the positions marked 19. These four connecting pins 13 serve purely as the connection between the lowest layer 11 and the second layer 11 viewed from the bottom. Said second layer 11 is shown in FIG. 2b, in which it is made clear that the positions 21 of those connecting pins 13 serving as the connection between the following third layer 11 and the second layer 11 are offset from the positions 19 of those connecting pins 13 serving as the connection between the bottom layer 11 and the second layer 11. The offset is selected such that as large a distance as possible exists between the positions 19 and the positions 21.

According to FIG. 2c, the positions 23 of those connecting pins 13 serving as the connection between a following fourth layer 11 and the third layer 11 coincide, in plan view, with the positions 19 of those connecting pins 13 serving as the connection between the bottom layer 11 and the second layer 11. It can further be seen from FIGS. 2d and 2e that the positions 25 of those connecting pins 13 serving as the connection between the fifth and final layer 11 and the fourth layer 11 also coincide, in plan view, with the positions 21 of those connecting pins 13 serving as the connection between the second layer 11 and the third layer 11.

The offset arrangement of the connecting pins 13 according to FIG. 2a-2e prevents thermal bridges and minimizes the gas permeability of the high-temperature seal during use of the layered composite material. Overall, the invention allows the provision of a multi-layer graphite seal having high temperature resistance and corrosion resistance, without the need for complex gluing, carbonization and graphitization processes.

The following is a summary list of reference numerals and the corresponding structure used in the above description of the invention:
11 layer
13 connecting pin
14 blind hole
18 buffer zone
19 positions of the connecting pins for connecting the first and the second layer
21 positions of the connecting pins for connecting the second and the third layer
23 positions of the connecting pins for connecting the third and the fourth layer
25 positions of the connecting pins for connecting the fourth and fifth layers
L longitudinal axis
E layer plane

1. A layered composite material, comprising:
at least two layers of graphite foil;
at least one connecting pin connecting said at least two layers of graphite foil to one another, said at least one connecting pin engaging in each of said at least two layers with a form-fit.

2. The layered composite material according to claim 1, wherein said at least two layers of graphite foil are interconnected by said at least one connecting pin which engages in said layers with a form-fit and with a force-fit.

3. The layered composite material according to claim 1, wherein a longitudinal axis of said at least one connecting pin extends transversely (perpendicular or oblique) with respect to a planar extension of the layered composite material.

4. The layered composite material according to claim 1, wherein at least one end of said at least one connecting pin is offset backwards by a buffer distance from a closest outer surface of the layered composite material.

5. The layered composite material according to claim 1, wherein said at least two layers of graphite foil are interconnected solely by way of said at least one connecting pin and without any adhesive.

6. The layered composite material according to claim 1, wherein said at least two layers of graphite foil have a thickness of between 0.2 mm and 10 mm.

7. The layered composite material according to claim 6, wherein each of said at least two layers of graphite foil has a thickness of between 1 mm and 3 mm.

8. The layered composite material according to claim 1, wherein the layered composite material has a total thickness of between 2 mm and 50 mm.

9. The layered composite material according to claim 8, wherein the layered composite material has a total thickness of between 5 mm and 30 mm.

10. The layered composite material according to claim 1, wherein said at least two layers of graphite foil are between 3 and 50 layers of graphite foil.

11. The layered composite material according to claim 10, wherein said at least two layers of graphite foil are 4 or 5 layers of graphite foil.

12. The layered composite material according to claim 10, wherein said at least two layers of graphite foil are at least three layers of graphite foil interconnected by at least two said connecting pins, and wherein each of said at least two connecting pins engage only in two mutually adjacent layers of said at least three layers of graphite foil.

13. The layered composite material according to claim 1, wherein said at least one connecting pin is formed of a material selected from the group consisting of carbon, graphite, composite materials containing carbon fibers, felt, silicon carbide, metals, ceramic materials and any combination of two or more of the aforementioned materials.

14. The layered composite material according to claim 1, wherein said at least one connecting pin has an outer diameter of between 1 mm and 5 mm.

15. The layered composite material according to claim 14, wherein said at least one connecting pin has an outer diameter of between 2 mm and 3 mm.

16. The layered composite material according to claim 1, wherein said at least one connecting pin has a length that is shorter than a sum of the thicknesses of the layers of graphite foil interconnected by said connecting pin.

17. The layered composite material according to claim 1, wherein each of said at least two layers of graphite foil is formed with a recess for receiving said at least one connecting pin.

18. A component, comprising at least one a layered composite material according to claim 1 configured as a seal.

19. A seal device, comprising a layered composite material according to claim 1 disposed to seal against temperatures of at least 600° C.

20. The seal device according to claim 19, configured and disposed to seal against temperatures of at least 1800° C.
